(19) United States
(12) Patent Application Publication
(10) Pub. No.: US 2010/0098808 A1
(43) Pub. Date: Apr. 22, 2010

(54) PROCESS OF MAKING A FROZEN BEVERAGE FROM A FROZEN CONFECTION WITH INCREASED SURFACE AREA AND VOIDS

(76) Inventors: Madansinh Vaghela, Bakersfield, CA (US); Nishant Joshi, Bakersfield, CA (US); Hoo Tung Vincent Chan, Bakersfield, CA (US); Dinakar Panyam, Fremont, CA (US)

Correspondence Address: WINSTON & STRAWN LLP;PATENT DEPARTMENT, 1700 K STREET, N.W., WASHINGTON, DC, 20006, US

(21) Appl. No.: 12/491,714

(22) Filed: Jun. 25, 2009

Related U.S. Application Data
(60) Provisional application No. 61/107,236, filed on Oct. 21, 2008.

(51) Int. Cl. A23G 9/44; A23G 9/50; A23G 3/50; A23G 9/48; A23L 2/02; A23G 9/46; A23L 2/38; A23C 9/18; A23F 3/14; A23F 5/14; C12G 3/08

(52) U.S. Cl. 426/66; 426/279; 426/104; 426/85

(57) ABSTRACT

The invention provides a method of making a frozen beverage by arranging a frozen confection in a container with the frozen confection having a three-dimensional shape with a surface area to volume ratio higher than the same volume of frozen confection which assumes the shape of the container and being arranged in the container to provide one or more open spaces or cavities including at least one extending through or around the frozen confection to the bottom of the container. The open spaces or cavities allow liquid to penetrate and enter into the frozen confection to facilitate mixing of the liquid and the frozen confection to form the frozen beverage upon demand.

### CROSS-REFERENCE TO RELATED APPLICATIONS

The application claims the benefit of U.S. provisional application No. 61/107,236, filed Oct. 21, 2008, the entire content of which is expressly incorporated herein by reference thereto.

### FIELD OF INVENTION

The invention relates to a process of making a frozen beverage as well as to certain products which are used in this process. The process and products utilize a frozen confection which has an increased surface area as well as voids/open spaces that facilitate easy mixing with an added liquid to form the frozen beverage.

### BACKGROUND OF THE INVENTION

Frozen beverages such as milkshakes and smoothies have become increasingly popular, and exceeded its anticipated seasonality. Currently, these frozen drinks require multiple steps of preparation before consumption. For example, a milkshake or smoothie is often prepared by mixing hand-scooped ice cream or sherbet with milk or water followed by blending using various mechanical means. While this technique is well established, it is generally conducted in fast food or restaurant establishments, and is inconvenient for a consumer at home due to the amount of equipment or effort needed to prepare a single serving.

Accordingly, there remains a need in the industry for making frozen drink products that do not require extensive preparation prior to consumption, and this need is now met by the present invention.

### SUMMARY OF THE INVENTION

The invention relates in general to a method of making a frozen beverage which comprises arranging a frozen confection in a container with the frozen confection having a three-dimensional shape with a surface area to volume ratio higher than the same volume of frozen confection which assumes the shape of the container and one or more open spaces, cavities or air pockets including at least one extending through or around the frozen confection to near the bottom of the container, wherein the open spaces, cavities or air pockets allow liquid to penetrate and enter into the frozen confection to facilitate mixing of the liquid and the frozen confection to form the frozen beverage.

Typically, the shape of the frozen confection is provided by extruding the frozen confection into the container. In one embodiment, a liquid can be added to the arranged frozen confection immediately after arrangement in the container with some minor stirring or shaking to form the frozen beverage. In another embodiment, the method includes hardening the frozen confection shape and packaging the container and shape for storage and transport so that the frozen beverage can be made at a later time upon demand by the addition of a liquid. The frozen confection generally has a viscosity of about 150 to about 300 N sec/m² prior to hardening so that it is able to maintain its shape. The shape is usually extruded at a temperature of from about −4° C. to about −17° C., and then hardened at a temperature of from about −20° C. to about −35° C.

The shape is dispensed such as by extruding or spraying using multiple nozzles to achieve the desired configuration, e.g., a rosette, a swirl, a strand, or another pattern. Also, the open spaces of the frozen confection may include one or more cavities oriented in a central portion of the shape and preferably extending all the way to the container bottom to facilitate entry of liquid therein. Advantageously, the frozen confection has a surface area to volume ratio about 1.5 to about 5 fold higher than the same volume of frozen confection which assumes the shape of the container. If desired, additives or inclusions may be provided in the frozen confection or in the container to enhance the functionality or organoleptic properties of the frozen beverage that is prepared.

The types of frozen confection that are suitable for use in the inventive methods include a conventional ice cream, sorbet, sherbet, or frozen water-ice; or modified ice creams formulated to be more concentrated with sweetness and flavor than a conventional ice cream. The frozen confection is typically aerated to an overrun of between 50% to 150% and preferably around 100%. The frozen confection comprises sugar and a hydrocolloid and optionally, one or more emulsifiers or proteins. Preferably, the frozen confection comprises sugar, a hydrocolloid, an emulsifier, dairy solids and fat.

The invention also relates to a product comprising a frozen confection in a container with the frozen confection having a three-dimensional shape with a surface area to volume ratio higher than the same volume of frozen confection which assumes the shape of the container and being arranged in the container to provide one or more open spaces, cavities or air pockets including at least one extending through or around the frozen confection to the bottom of the container, wherein the open spaces, cavities or air pockets allow liquid to penetrate and enter into the frozen confection to facilitate mixing of the liquid and the frozen confection to form the frozen beverage. The product is packaged for storage and transport. The product may also include a spoon or straw associated with the container for use in preparing a frozen beverage by stirring after the addition of a liquid to the container. The frozen confection, container and optionally the spoon or straw are packaged together to facilitate transport and sale.

The invention also relates to the use of these products for the preparation of a frozen beverage. To make the frozen beverage by the method of by use of the products, a liquid is added to the container; and the liquid and frozen confection are mixed by stirring with a spoon or straw for less than one minute to form the frozen beverage. Due to the fact that the surface area is sufficiently large to facilitate stirring, and sufficiently open to allow the liquid to penetrate and enter into the shape to facilitate mixing of the liquid and the frozen confection, minimal effort is needed to prepare the frozen beverage. Suitable liquids include water, milk, fruit juice, a fruit syrup, coffee, tea, or an alcoholic beverage and the necessary stirring can be achieved in less than a minute or two by mixing with a simple implement such as a spoon or a straw.

### BRIEF DESCRIPTION OF THE DRAWINGS

The invention will be better understood in relation to the attached drawings illustrating preferred embodiments, wherein:

FIG. 1 illustrates a nozzle arrangement used in preparing a rosette product in a cup;

FIGS. 2A and 2B show frozen confections in a rosette shape, highlighting the increased surface area that is exposed as a result of using the nozzle filling method;

FIG. 3 shows a cup with the rosette shape sliced in half to reveal the interior channels that allow milk to disperse quickly in the frozen product; and

FIG. 4 shows an amount of milk added to rosette shape and cup of FIG. 3, wherein the milk has filled the voids and spaces of the rosette shape.

### DETAILED DESCRIPTION OF THE INVENTION

The invention relates to a process of preparing a frozen beverage such as milkshake and smoothie, in a rapid and convenient manner, with a simple addition of a liquid into a container housing a frozen confection which has an increased surface area and open spaces or porosity. The surface area is greater than that of the same volume of ice confection when it is packed in the container or present in the container as one or more scoops or boules, the latter being the usual starting point for making a frozen beverage such as a milkshake in the consumer's home. The invention avoids the messiness and difficulty in mixing compared to the use of such scoops and boules, as well as the avoidance of the use of high intensity electronic mixing devices. Furthermore, due to the ease of mixing of the liquid with the ice confection shape, spilling during mixing, stiffness of the initial ice confection and an end product having separated ice confection lumps and unmixed liquid portions is avoided. The inability to have similar uniform viscosity and coldness is also avoided. The increased surface area and open spaces, voids, cavities or air pockets facilitate the mixing of a liquid with the frozen confection without the use of mechanical mixers or blenders. This is particularly useful when a single serving of such beverage is desired as simple mixing with a spoon or by shaking the container with the liquid and shaped ice confection therein is all that is required to make the frozen beverage.

To facilitate easy mixing with the liquid to form the frozen beverage, the frozen confection does not assume the shape of the container. Instead, it has aesthetically pleasing three-dimensional shape that provides an increased surface area as well as voids/open spaces. One or more nozzles having dies of specific shapes can be used to extrude the frozen confection to produce the desired shape. The shape should have an increased surface area to volume ratio and a sufficient porosity due to the presence of voids and/or air pockets to facilitate easy mixing with the liquid to form the frozen beverage. This is easily achieved when the product has an overrun of 50 to 150% due to the use of such nozzles with the incorporation of the appropriate emulsifiers therein.

The shape of the frozen confection is preferably provided by extrusion or spray dispensing through multiple nozzles with dies of specific shapes at normal ice cream extrusion temperatures, i.e. about −4° C. to about −17° C. The types of suitable shapes exiting the nozzle can vary over a wide range and can include cylindrical shapes (i.e., strands), generally cylindrical shapes that have irregularities, such as raised portions (e.g., swirls such as the shape of whipped cream that is provided by an aerosol dispenser or the shape of cake frosting decorations), or other shapes, such as flowers, rosettes, or the like. The skilled artisan knows how to select the appropriate types of extrusion nozzles to achieve these shapes so no further description is required here.

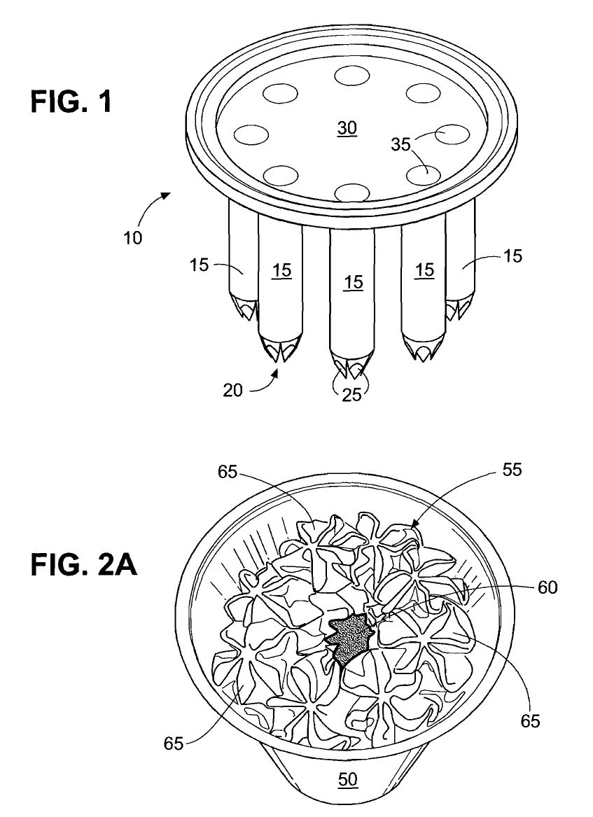

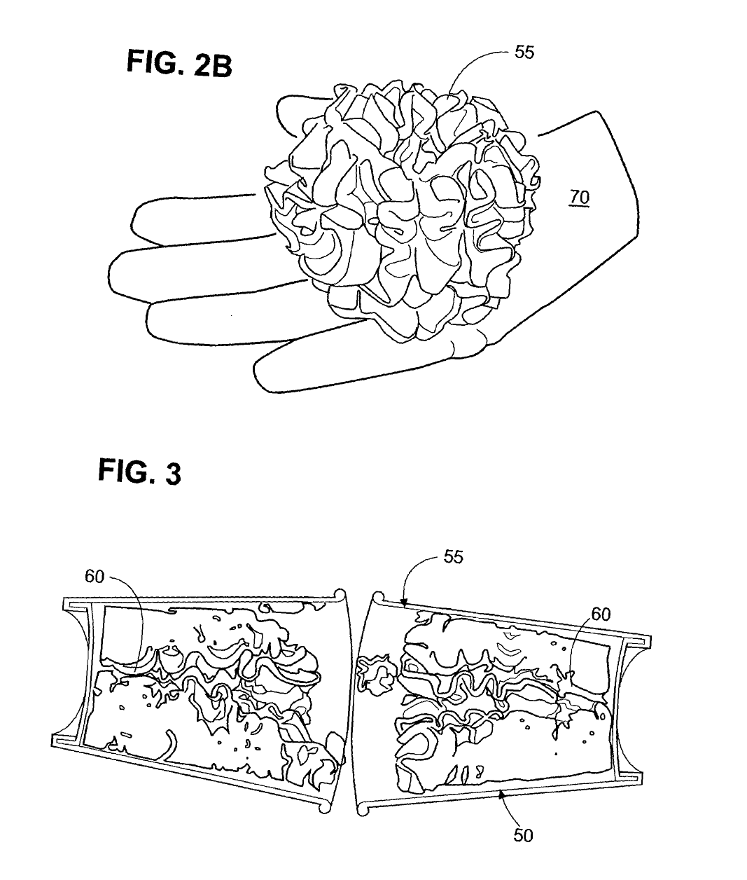

A specifically preferred nozzle arrangement 10 is shown in FIG. 1. This arrangement includes a cluster of eight spaced nozzles 15 each having a star shaped tip 20 with faceted edges 25 that each create a star shaped foam of the ice confection in a manner similar to that obtainable from whipped cream that is dispensed from a pressurized container. The nozzle arrangement 10 includes a base 30 for connection to the outlet of an ice confection extruder or a similar dispensing device (not shown). The nozzles 15 are mounted on the base such that the ice confection enters the nozzles 15 through respective apertures 35. For the necessary strength and performance characteristics, as well as to facilitate manufacture of the nozzle arrangement 10, a material such as stainless steel is used. Other metals, or in some cases engineering plastics, can be used depending upon the specific design of the nozzle or nozzle arrangement 10. The nozzle arrangement 10 shown in FIG. 1 can prepare the rosette patterns shown in FIGS. 2A, 2B and 3.

In FIG. 2A, the result of spraying the ice confection into a cup 50 is shown, with the shape of the ice confection assuming a rosette pattern 55 that includes many open areas and voids or air pockets that later facilitate mixing of the frozen confection with a liquid. Also, as shown, the shape has a generally central opening 60 that is provided due to the spacing of the nozzles 15 in the nozzle arrangement 10. The opening preferably extends all the way to the bottom of the container, but it can expend part way to near the bottom with good results. A single opening which extends through or around the ice confection by at least 65% to as much as 95% or even 100% of the height of the ice confection has been found to be suitable. Multiple openings can be used and in that situation, less deep openings can be provided. These opening(s) as well as the other voids or air pockets are present to provide sufficient volume to enable the liquid to contact the ice confection so that a frozen beverage can be easily and simply prepared. A nozzle arrangement as shown is capable of achieving the desired spacing to facilitate contact of the liquid with the ice confection. Each nozzle 15 provides a star shaped deposit 65 with eight deposits provided in total, one from each nozzle 15 of the nozzle arrangement 10. The deposits 65 are irregular with the spaces between them creating the voids and air pockets. Of course, the number of specific nozzles and their spacing can be varied as desired to achieve the necessary shape that can receive the liquid and make it easier to mix compared to a solid or other shape having a lesser surface area.

FIG. 2B shows the rosette pattern 55 dispensed into a person's hand 70 to show how the outer portion of the shape appears. The irregularities in the surface of the star shaped deposits 65 that create the desired voids and air pockets are more clearly shown in this figure. Of course, other uniform or non-uniform openings or spaces can be provided to achieve the same degree of contact between the liquid and the ice confection.

FIG. 3 further shows the voids and air pockets when the shape is present in a cup or container. In this figure, a cup 50 filled with the rosette pattern 55 is cut in half after the ice confection is dispensed therein and is frozen. The central opening 60 forms a channel that enables the liquid to penetrate into the pattern 55 and to the bottom of the container 50.

Other nozzles and shapes can be used. When strands are used, multiple strands can be arranged in a non-regular or random patterns so that open spaces or voids are provided for the liquid. The thickness of the strands can also be selected for optimum formation of a “bird nest” type structure that again has multiple open spaces for entry of liquid. Other types of cavities or open spaces are useful since in each case the liquid is able to penetrate into the shape and contact the frozen confection in a manner that facilitates formation of the frozen beverage with a minimum amount of mixing. Typically, the open volume around or through the ice confection represents about 25% to 80% and preferably 40 to 65% of volume of the container. After mixing of the liquid and ice confection, the resulting frozen beverage product has a homogeneous and uniform consistency without lumps of ice confection and unmixed liquid portions. This enables the product to be prepared upon demand as desired by the consumer with minimum effort.

After arranging or forming the frozen confection shape in the container, the shape is hardened at about −20° C. to about −35° C. The unique shape of the frozen confection results in an surface area to volume ratio and porosity about 1.5 to about 5 fold higher than that of the same volume of frozen confection assuming the shape of the container as a result of conventional filling methods. Since the liquid can easily penetrate through the frozen confection of the invention, the preparation of a frozen beverage can be completed in less than a few minutes and often in less than a minute. In contrast, when a container is filled with the frozen confection such that the flat top surface is the only surface area, the liquid needs at least 3 to 5 minutes before reaching the bottom of the container. Even if scoops or boules of frozen confection are used, at least a few minutes are need for the liquid to be mixed with the frozen confection. Furthermore, the amount of force or energy needed to achieve this mixing is greater than that of the present invention. Such traditional method of preparation is not only difficult but also messy. For example, there is usually spill during mixing. Also the end product is often stiff, with lumps and liquid portions, which make it impossible to achieve similar uniform viscosity and coldness.

The stiffness or viscosity of the frozen confection after extrusion depends on the composition of the frozen confection as well as the extrusion temperature. Preferably, the viscosity of the frozen confection is in the range of about 150 to about 300 N sec/m², which is the normal range for ice cream products between −5.5° C. and −7° C. At this range of viscosity, the frozen confection holds its three-dimensional shape without collapsing before hardening so that it does not assume the shape of the container. The resulting product is then rapidly cooled to the hardening temperatures of −20° C. to −35° C. This treatment further increases the percentage of frozen water in the product from approximately 40-60% to 70-95%, thereby ensuring that the frozen confection maintains its shape and spatial dimensions through the cold distribution chain until preparation by the consumer.

The frozen confection preferably has distinct shapes such as rosettes, swirls, strands, or other regular patterns that display a unique visual appearance. In another embodiment, the open portions of the frozen confection form one or more central cavities so that the liquid can access to center of the frozen product to further speed up the mixing process. Inclusions such as pieces of fruits, nuts, cereal, cookies or candies may be provided in the cavity to increase the organoleptic properties of the frozen beverage. Of course, it is also possible to provide the inclusions in the frozen confection itself if the inclusions are sufficiently small to pass through extrusion nozzles. The skilled artisan can best decide how to provide inclusions in the product.

Preferably, the frozen confection has an overrun of 50-150% for easy mixing with the liquid. When the frozen confection is a fruit-based sherbet, specific emulsifiers such as polyglycerol ester (PGE), other dairy solids or fat may be included to achieve a desirable overrun. When the frozen confection is an ice cream, it may be appropriately more concentrated with sweeteners and flavor than the normal ice cream recipe so that the frozen beverage achieves a desirable level of sweetness and flavor after the frozen confection has been mixed with the liquid. The frozen confection may further comprises sugar and hydrocolloid.

The container for housing the frozen confection can be a cup or other vessel which is used both for transport and storage of the frozen confection as well as for preparing the frozen beverage. The container can be of any suitable single serving size. Typically, the container will be able to accommodate a 12 ounce milkshake or smoothie product, but other container sizes such as those that can hold 4, 8, 16 or 20 ounces of product can be used. Typical materials for the container are treated paper, paperboard, plastics, paper-plastic laminates, metal foils, paper-foil composites, or any other material that is used for holding fluids or beverages. The shape of cup is not critical and conventional cylindrical shapes are entirely suitable. Generally, styrofoam is suitable and is the preferred material for the container from a cost and availability standpoint.

As noted herein the cup can include a spoon or straw associated therewith for use in mixing the liquid with the frozen confection. The straw can be of the type that has a widened open dent that acts as a spoon while the hollow tubular body allows to beverage to be consumed by sucking action. The spoon or straw can be attached to the cup and packaged therewith so that everything is provided for making the frozen beverage except for the liquid. This enables the consumer to prepare a frozen beverage on demand just by the simple addition and mixing of the desired liquid.

In some situations, the frozen beverage can be made immediately after arranging the frozen confection in the container. This would be used in a food service or fast food establishment where the nozzles would form part of an ice cream dispenser and the frozen confection is dispensed directly into a cup and the liquid is later added to form the frozen beverage. It also could be used in a self-serve setting and would allow the customer to select different liquids to add to the frozen confection to form a beverage of choice.

In other situations, such as for home use, the frozen confection and container are packaged for transport to a retail establishment, the consumer would purchase the product, transport it home and maintain it in the freezer until a frozen beverage is desired. Various packagings can be used. The frozen confection and container can be wrapped or sealed with, treated paper, plastic, paper-plastic laminates, metal foils, paper-foil composites, or any other material suitable for this purpose. The sealed container can be further packaged in a paper or cardboard box or carrying case for transport between manufacturing, sales and consumer home locations where it is maintained under refrigeration temperatures used for ice creams. After the product is brought home by the consumer, it can be stored in the freezer until use. At that time, the product would be retrieved from the freezer, a liquid added and the frozen beverage formed as disclosed herein.

In a preferred embodiment, the liquid is added into the container that holds the frozen confection, and the spoon, straw or similar simple utensil is used to mix the ingredients. Preferably, the spoon or straw that is provided with the cup is used for this purpose. The amount of liquid would generally vary from about 20 to 75% and preferably 35% to 60% of the total weight of the frozen confection and the liquid. The specific liquid and frozen confection selected, along with the resulting desired thickness of the frozen beverage would contribute to the variation of the amount of liquid added. It is expected that a skilled artisan can easily determine the preferred amount of liquid to be used through routine tests.

Various combinations of frozen beverages can be achieved by the use of appropriate frozen confection and liquid combinations. The frozen confection can be made with any one of a number of different flavors of ice cream, sherbets, sorbets, water ice or the like, including low fat or light varieties. Generally, fluids such as water, whole milk, chocolate milk, skim milk or the like can be used to obtain a milkshake while a fruit juice can be used to obtain a smoothie or slush product. Preferably, the fruit juices to be used are made of natural ingredients obtained from a fruit, vegetable or edible plant by crushing, squeezing or related operations. These juices may be filtered, strained, passed through a sieve, resin beds, clay or diatomaceous earth bed or filters, or ion exchange resins to give a juice, a juice concentrate, purees, and so-called modified juices. Specific types of juices which can be utilized in the present invention include fruit juice, concentrated fruit juice, fruit puree, fruit puree concentrate, modified juices, as well as modified concentrated juices and the like. Modified juices, for instance, would include ion exchange treated and/or ultrafiltered juices, or deodorized and decolorized ones. Examples of a few of the many specific juices which can be utilized in the product of the invention include, for example, peach concentrate, pear concentrate, blackberry puree, cranberry juice, apple concentrate, white grape juice, orange juice concentrate, grape concentrate, lemon juice concentrate, apple juice concentrate, etc. Of course, many other types of juices whether in the form of a puree, concentrate, or a juice can be utilized, depending upon the desired end flavor.

In addition to the frozen confection, the container may also include other components. As noted herein, pieces of fruits, nuts, cereal, cookies or candies can be included in the container for increasing the organoleptic properties of the frozen beverage. It is also possible to have these items sprinkled on the surface of the frozen confection instead of being present in the frozen confection or deposited in a cavity of the frozen confection shape. For example, these pieces can be provided in a separate container or in the lid compartment of the container and added to the frozen beverage just prior to consumption.

If desired, the liquid itself can include the necessary flavorants or colorants to achieve the desired flavor or color of the frozen beverage. These flavorants or colorants can be in the liquid that is to be added or multiple liquids, one of milk or juice, a separate flavorant liquid and/or a separate colorant liquid can be added depending upon the desired properties of the final product. Alternatively, the flavorants or colorants can be added after the frozen beverage is formed and then combined therein by use of a spoon or straw. This enables a partially colored or flavored product to be formed if desired.

For certain frozen beverages, small amounts of various flavor enhancers or modifiers, generally food grade acids, can be utilized to impart tartness, enhance flavor, prevent oxidation of the ingredients or the like. For example, citric acid and other organic acids such as malic acid may be utilized to impart tartness or accentuate the flavor of the mixture. These are generally present in the liquid but if necessary can be included with the frozen confection. Also, to prevent oxidation, ascorbic acid can be utilized.

### EXAMPLES

The following examples illustrate preferred embodiments of the invention.

| | Example 1 | Example 2 | |
|---|---|---|---|
| | VANILLA | BERRY | |
| INGREDIENT | SHAKE | SMOOTHIE | SOURCES OF |
| MIX MAKING | % | % | INGREDIENTS |
| WATER | 22-30 | 48-62 | |
| CONDENSED SKIM | 31-38 | | Generic |
| MILK | | | |
| CREAM | 9-14 | | Generic |
| SUGAR | 12-21 | 22-32 | ADM |
| CORN SYRUP SOLIDS | 2.5-7.6 | 8-16 | ADM |
| (CSS DE 36) | | | |
| DEXTROSE | 2-8 | | UNIVAR |
| (CERELOSE) | | | |
| CORN STARCH | 0.4-1.1 | | Tate & Lyle |
| EMULSIFIERS/ | 0.18-0.45 | 0.08-0.32 | Polypro/Danisco |
| STABILIZERS | | | |
| TOTAL | 100.00 | 100.00 | |

| INGREDIENT | Example 1 | Example 2 | SOURCES OF |
|---|---|---|---|
| FREEZING PROCESS | % | % | INGREDIENTS |
| BASE MIX | 98.6-99.7 | 73-81 | From above |
| BERRY PUREE | | 27-19 | Sabroso/ |
| VANILLA FLAVOR | 0.30-1.4 | | Firmenich/Danisco |
| CITRIC ACID | | 0.3 | UNIVAR |
| TOTAL | 100.00 | 100.00 | |

Wherever appropriate, a foam stabilizing agent was used to create and maintain a finely dispersed foam. Typical foaming agents like polyglycerol ester (PGE) or sugar esters, protein hydrolysates, caseinate, whey protein, egg white powder etc could used as required in small quantities not exceeding 1.5% by weight. It was also determined to be advantageous to use an emulsifier like polyglycerol monostearate in certain specific recipes.

### Procedure for Making the Frozen Confection Composition:

### Mix Preparation:

A liquefier was filled with appropriate amount of water, to which sugar, corn syrup and dextrose were added with constant mixing. Requisite emulsifiers and stabilizers were added and further mixed for about 5 minutes followed by liquid ingredients like milk and cream.

The pre-mix was pasteurized using standard HTST (High Temperature Short Time method) using a typical thermal regime of 182° F. for 60 seconds or equivalent.

The pasteurized mix was then cooled to 40° F. and stored till used.

### Freezing and Filling Procedure:

Flavors and colors were added prior to freezing in a standard closed dasher type ice cream freezer. Overrun was achieved by incorporating air under pressure. The mix was simultaneously frozen until the required viscosity and temperature were achieved.

The semi-frozen product from the freezer was extruded through specific nozzle configuration arranged at the end of the exit pipe from the freezer. Filling line pressure is typically about 25 psig.

Multiple nozzles, typically eight per filling head, were arranged such that an aesthetically pleasing appearance was consistently achieved in the cup in which the product was filled. The internal diameter of each nozzle is about 9.8 mm.

### Comparative Example

To illustrate the advantages conferred by increasing the surface area on easy mixing of liquid with the frozen product of the invention, another cup of the same size was filled with the same ice confection except without using the nozzle arrangement 10. This ice confection assumed the shape of the container and exhibited a relatively flat surface exposed at the top of the confection. When a volume of milk was added to the product in the cup, the milk formed a separate layer that remained on the top of the frozen surface.

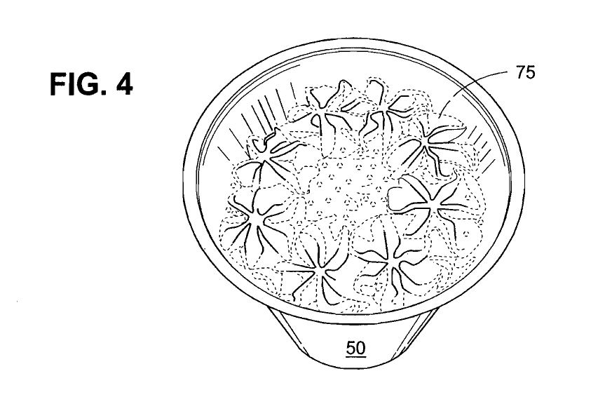

In comparison, when the same quantity of milk was added to a cup containing the frozen product in the shape of the rosette pattern 55 as shown in FIG. 2A, the milk quickly penetrated and dispersed into the shape due to the voids and air pockets that were provided, all the way through to the bottom of the container, as shown in FIG. 4, with only the peaks of the rosette pattern 75 still being visible. This penetration of the ice confection by the liquid facilitates mixing and formation of the frozen beverage.

After adding milk to the ice confection having the rosette shape, the combination was stirred gently with a spoon, and it soon transformed into a smooth milkshake in approximately 25-40 seconds. In contrast, when milk was added to the extruded ice confection made without the rosette pattern and mixed, it took more than 2 minutes of vigorous mixing before the liquid and frozen solid could be combined into a frozen beverage, and even there, the appearance of this product was lumpy and not as uniform or smooth as in the case of the product made with the rosette pattern.

The embodiments and examples illustrated and discussed in this specification are intended only to teach those skilled in the art the best way known to the inventors to make and use the invention. The above-described embodiments of the invention may be modified or varied, without departing from the invention, as easily appreciated by those skilled in the art in light of the above teachings. Accordingly, all expedient modifications readily attainable by one of ordinary skill in the art from the disclosure set forth herein, or by routine experimentation therefrom, are deemed to be within the spirit and scope of the invention as defined by the appended claims.

1. A method of making a product to form a fiozen beverage, which comprises arranging a frozen confection in a container with the frozen confection having an extruded, free-standing three-dimensional shape with a surface area to volume ratio higher than the same volume of frozen confection which assumes the shape of the container, and open spaces or cavities at least partially surrounding the three- dimensional shape of the frozen confection and located between the frozen confection and container sidewall, and at least one cavity extending through the three-dimensional shape of the frozen confection to near the bottom of the container, wherein the frozen confection has a surface area to volume ratio about 1.5 to about 5 fold higher than the same volume of frozen confection which assumes the shape of the container and wherein the open spaces or cavities allow liquid to penetrate and enter into the frozen confection to facilitate mixing of the liquid and the frozen confection to form the frozen beverage.

2. The method of claim 1, wherein the frozen confection is aerated to an overrun of between 50% to 150%.

3. The method of claim 1 wherein the open spaces and cavities have irregular shapes and extend from the top of the frozen confection to the bottom of the container.

4. The method of claim 1, which further comprises providing additives or inclusions in the frozen confection or in the container to enhance the functionality or organoleptic properties of the frozen beverage that is prepared.

5. The method of claim 1, wherein the shape of the frozen confection is provided by extruding the frozen confection into the container.

6. The method of claim 5, which further comprises hardening the frozen confection shape and packaging the container and shape for storage and transport.

7. The method of claim 6, wherein the frozen confection after extrusion has a viscosity that is able to maintain its shape during hardening.

8. The method of claim 6, wherein the shape is extruded at a temperature of from about −4° C. to about −17° C., and is hardened at a temperature of from about −20° C. to about −35° C.

9. The method of claim 6, wherein the shape is extruded using multiple nozzles, and is a rosette, a swirl, or one having irregularities or raised portions.

10. The method of claim 1, wherein the open space of the frozen confection includes one or more cavities oriented in a central portion of the three-dimensional shape of the frozen confection and extending to the container bottom to facilitate entry of liquid therein.

11. The method of claim 1, wherein the frozen confection is an ice cream, sorbet, sherbet, or frozen water-ice.

12. The method of claim 1, wherein the frozen confection comprises sugar and a hydrocolloid and optionally, one or more emulsifiers or proteins.

13. The method of claim 1, wherein the frozen confection comprises sugar, a hydrocolloid, a polyglycerol ester (PGE) emulsifier, a dairy solid or fat.

14. The method of claim 1, which further comprises
adding a liquid to the container; and
mixing the liquid and the frozen confection by stirring with a spoon for less than one minute to form the frozen beverage.

15. The method of claim 14, wherein the liquid is water, milk, fruit juice, a fruit syrup, coffee, tea, or an alcoholic beverage.

16. A product comprising a frozen confection in a container made according to the method of claim 1, with the product provided in a sealed package for storage and transport.

17. The product according to claim 16, which further comprises a spoon or straw associated with the container and for use in preparing a frozen beverage by stirring after the removal of the product from the package and the addition of a liquid to the container.

18. The product according to claim 16, wherein the frozen confection, container and optionally the spoon or straw are packaged together.

19. A product for forming a frozen beverage, the product comprising a frozen confection in a container with the frozen confection having an extruded, free-standing three-dimensional shape with a surface area to volume ratio higher than the same volume of frozen confection which assumes the shape of the container and being arranged in the container to provide open spaces or cavities at least partially surrounding the three-dimensional shape of the frozen confection and located between the frozen confection and container sidewall, and at least one cavity extending through the three-dimensional shape of the frozen confection to near the bottom of the container, wherein the frozen confection has a surface area to volume ratio about 1.5 to about 5 fold higher than the same volume of frozen confection which assumes the shape of the container and wherein the open spaces or cavities allow liquid to penetrate and enter into the frozen confection to facilitate mixing of the liquid and the frozen confection to form the frozen beverage, wherein the product is provided in a sealed package for storage and transport.

20. The product of claim 19 wherein the open spaces and cavities extend from the top of the frozen confection to the bottom of the container and have irregularities or raised portions and at least one cavity is oriented in a central portion of the three-dimensional shape.
